(19) United States
(12) Patent Application Publication
(10) Pub. No.: US 2012/0279130 A1
(43) Pub. Date: Nov. 8, 2012

(54) Swinging-sliding door

(75) Inventors: Kenneth Wade Appeldoorn, Salmon Arm (CA); James David Grieve, Salmon Arm (CA)

(73) Assignee: SPACESAVER DOORS INC.

(21) Appl. No.: 13/067,074

(22) Filed: May 6, 2011

(51) Int. Cl. E06B 3/50

(52) U.S. Cl. 49/252

(57) ABSTRACT

A swinging-sliding door for use in interior doorways of buildings. The door mechanism includes first and second upper swing arms each having opposite inner and outer ends. The inner ends are rotatably mountable to first and second ends of the upper jamb member in the door frame for rotation in a substantially common horizontal plane between a closed position flush along the upper jamb member and an open position substantially perpendicular to the upper jamb member. The inner end of the second upper swing arm is mountable into substantially a corresponding intersection between the upper jamb member and a vertical jamb member. A slide having first and second ends is mounted in the upper channel of the door and so as to be aligned parallel with the upper jamb member. The slide has a length corresponding to the length of the upper channel of the door. The outer ends of said first and second swing arms are rotatably mounted respectively to said first and second ends of said slide.

### FIELD OF THE INVENTION

This invention relates to swinging-sliding doors used for interior doorways in buildings.

### BACKGROUND OF THE INVENTION

In the prior art applicant is aware of U.S. Pat. No. 5,921,613 which issued Jul. 13, 1999 to Breunig et al for an Arrangement for Guiding a Swing-Out Sliding Door on a Vehicle Body, wherein an arrangement is described which guides a swing-out sliding door of a vehicle body without a centre guiderail which is visibly disposed on the outside of the vehicle body sidewall. A linearly constructed guiderail is described which, respectively, is fixed within the door opening on its upper and lower edge on the vehicle body side. A roller carriage to which the sliding door is linked by way of a control arm parallelogram travels in each guiderail. One closing roller respectively guided in each guiderail travels at the end of the door closing sliding movement into a circular closing groove branching off the guiderail in the direction of the sliding door. The closing roller is fixed to one of the control arms of the control arm parallelogram. The closing groove is constructed such that its curvature center in the door closing position of the roller carriage coincides with the roller-carriage-side hinge access of the control arm carrying the closing rollers.

Applicant is also aware of U.S. Pat. No. 4,495,729 which issued Jan. 29, 1985, to Vritzke et al for a Pivotable Sliding Door for Vehicles wherein a pivotable sliding door is disclosed having a main track which is suspended in a door frame with a running track by its suspension means having to staggerly jointed partial carriages. The rollers of one of the partial carriages rolls in the main track and the rollers of the other partial carriage roll in the running track.

Applicant is also aware of U.S. Pat. No. 3,841,024 which issued Oct. 15, 1974 to Chang for a Sliding Window in which a sliding window is disclosed having a frame with a slidable panel and a further panel therein. The slidable panel is mounted on pivot arms coupled to slider means such that in its closed position the slidable panel is coplanar with the further panel and pressed against compression sealing means on the frame. On the opening movement, the slidable panel moves, by means of the pivot arms, away from the sealing means and out of the plan of the further panel to lie parallel thereto, whereby it can be overlapped with the further panel.

In the prior art applicant is also aware of U.S. Pat. No. 3,293,801 which issued Dec. 27, 1966 to Henning for an Apparatus for Mounting Sliding Doors wherein a mounting apparatus for sliding doors is disclosed that includes an upper track and a lower track, and a door carriage for each of the sliding doors moveable along the tracks. The upper and lower tracks are parallel and may be fixed to the frame of the doorway opening. Each door carriage extends along the tracks approximately one half of the width of the door. Connecting means link the top and bottom of the door to the carriage, the connecting means articulated so that the connected door is suspended or supported from the carriage at either a closed position near the tracks or at an opening position horizontally displaced from the tracks. The connecting links are hinged to the carriage and to the inner face of the door at hinge points such that when the door is displaced toward the tracks in the closed position the downward thrust of the door weight tends to keep the door closed.

### SUMMARY OF THE INVENTION

The present invention is a swinging-sliding door for use in interior doorways of buildings. The purpose of this door is to save the space typically used by a normal “swing-open” hinged door. The swinging-sliding door allows the user to reclaim some usable floor space otherwise taken up by the path of a standard hinged door when being opened or closed. This door eliminates the major modifications to the wall required to install a standard “pocket door” which requires modifications to the ceiling, floor, trim and paint, and may often require demolishing and replacing the wall altogether. The swinging-sliding door mechanism allows the door to swing out of the door frame on a set of rotating swing arms, and then slide along the wall fully exposing the door opening without interfering with pictures on the wall adjacent the door.—

In one aspect the present invention may be characterized as a swinging-sliding door mechanism for mounting a door into a door frame. The door frame has a horizontal upper jamb member and parallel vertical first and second jamb members depending downwardly from corresponding opposite first and second ends of the upper jamb member. The door has horizontal upper and lower channels formed in the upper most and lower most ends of the door. The door frame has a wall adjacent to it on which pictures maybe hung.

The door mechanism includes first and second upper swing arms each having opposite inner and outer ends. The inner ends are rotatably mountable to the first and second ends of the upper jamb member for rotation in a substantially common horizontal plane between a closed position flush along the upper jamb member and an open position substantially perpendicular to the upper jamb member. The inner end of the second upper swing arm is mountable into substantially a corresponding intersection between the upper jamb member and the vertical second jamb member.

The door mechanism also includes a slide having first and second ends and mountable in the upper channel of the door and so as to be aligned parallel with the upper jamb member. The slide has a length corresponding to the length of the upper channel of the door. The outer ends of said first and second swing arms are rotatably mounted respectively to said first and second ends of said slide.

The door mechanism also includes a third swing arm having an inner and an opposite outer end. The outer end is rotatably and slidably mountable to the lower channel in the door. The inner end of the third swing arm is rotatably mountable at a lower end of the second jamb member.

The door mechanism also includes an elongate rod having opposite upper and lower ends rigidity mounted to, so as to extend vertically between, the inner ends of said second and third swing arms respectively. As the second and third swing arms are rigidly mounted to the rod, rotation of either of said second or third swing arms causes corresponding rotation of the other swing arm.

In one embodiment, the slide includes a pair of drawer-type slides, each slide of said pair of drawer-type slides having a front and an opposite back. The slides are mounted back-to-back. An elongate plate is mounted sandwiched between the back-to-back slides, so that the fronts of the slides are oppositely disposed and mountable into the upper channel in the door. The outer ends of the first and second swing arms rotatably mounted to the plate. Advantageously, the first, second and third swing arms are longer than the thickness dimension of the door by a thickness of the pictures on the adjacent wall. For example, the swing arms may be substantially twice as long as the thickness dimension of the door. The door will thus clear over the pictures on the wall adjacent the door when the door slides to its open position on said slide.

In a preferred embodiment the rod is at least partially embedded in the second jamb member, and for example may be completely embedded in second jamb member. The upper and lower ends of the second jamb member may have notches therein. The second and third swing arms mate into the upper and lower notches respectively when said second swing arm is in its open position. The notches provide rotational stops that arrest rotation of the second and third swing arms when the second and third swing arms are substantially perpendicular to the door and the door frame.

At least one detent may be provided, for example located on one or more swing arms. The detent or detents, in combination with resiliently biased detent followers such as spring-loaded ball-bearings cooperating with corresponding detents, arrest the rotation of the swing arms when they are substantially perpendicular to the door and door-frame. Each detent inhibits rotation of the first or second swing arm below a rotational force applied thereto which is at least equivalent to a force acting on said first and second swing arms due to return sliding of the door along said slide from the door's open position to a position covering the door frame.

A rotatably mounted guide member maybe rotatably mounted on the outer end of the third swing arm. The guide member is sized to slide along and within the lower channel in the door.

### BRIEF DESCRIPTION OF THE DRAWINGS

FIG. 1 shows the door assembly in its fully closed position

FIG. 2 shows the door assembly in its fully open position

FIG. 3 shows the door assembly partially rotated out of the door jamb.

FIG. 4 shows the door assembly fully rotated out from the door jamb.

FIG. 5 shows the door assembly in an intermediate slide position.

FIG. 6 shows the door assembly partially open, with the door jamb not shown and the hardware associated with the swinging-sliding mechanism visible.

FIG. 7 shows a close-up of the portion of the swinging-sliding mechanism located on the top of the door.

FIG. 8 shows the swinging-sliding mechanism mounted in the door jamb, with no door attached.

FIG. 9 shows a close-up of the bottom inside corner of the door jamb where the swing arm and pivot equalizer rod mounts.

FIG. 10 shows the swinging-sliding mechanism hardware located in the channel in the top of the door.

FIG. 11 shows an exploded view of the swinging-sliding mechanism hardware located in the channel in the top of the door.

FIG. 11a is an enlarged view of a portion of FIG. 11.

FIG. 11b is a sectional view along line 11b-11b in FIG. 11a.

FIGS. 12, 13 and 14 show the bottom edge of the door and the swinging-sliding mechanism in closed, partially open, and fully open positions respectively.

FIG. 15 shows the door jamb features accommodating the swinging-sliding mechanism.

FIG. 16 shows a close-up of the top inside of the doorjamb accommodating the swinging-sliding mechanism.

FIG. 17 shows a close-up of the bottom inside of the door jamb accommodating the swinging-sliding mechanism.

### DETAILED DESCRIPTION OF EMBODIMENTS OF THE INVENTION

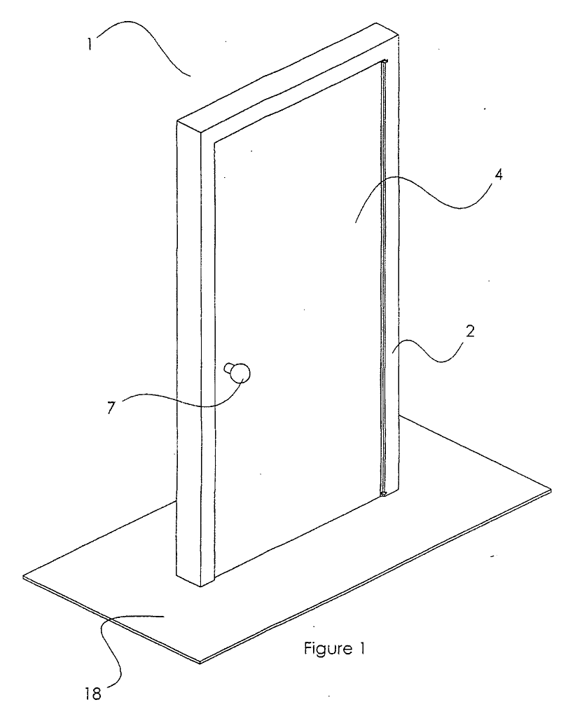

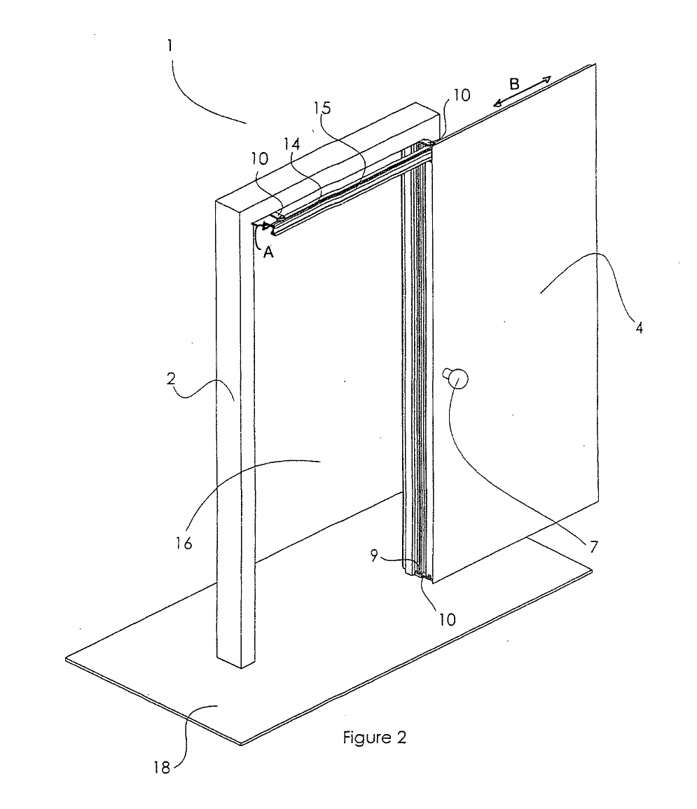

The present invention is a swinging-sliding door for use in interior doorways of buildings. FIG. 1 shows the door assembly 1 in its fully closed position, with the swinging-sliding mechanism hardware, better described below, almost completely hidden. FIG. 2 shows the door assembly 1 in its fully open position with the swinging-sliding mechanism visible.

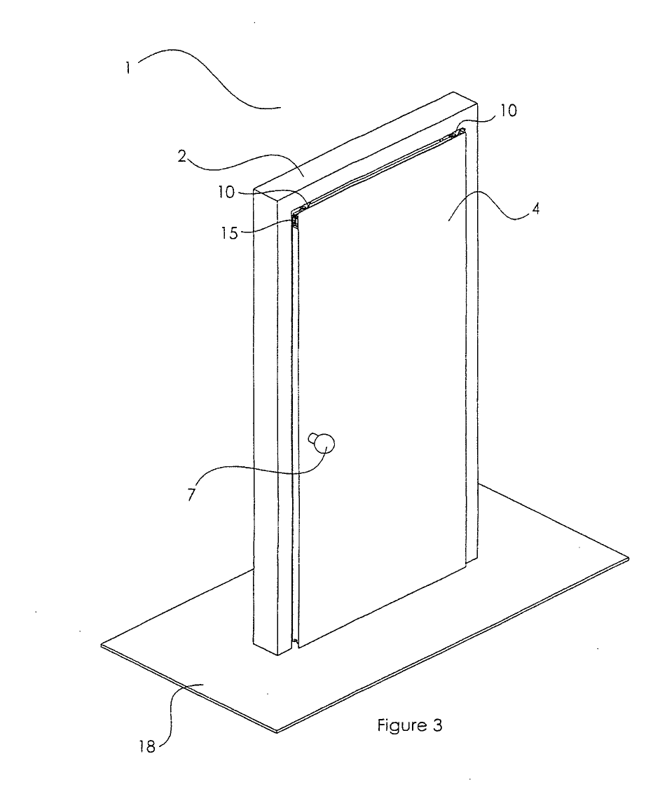

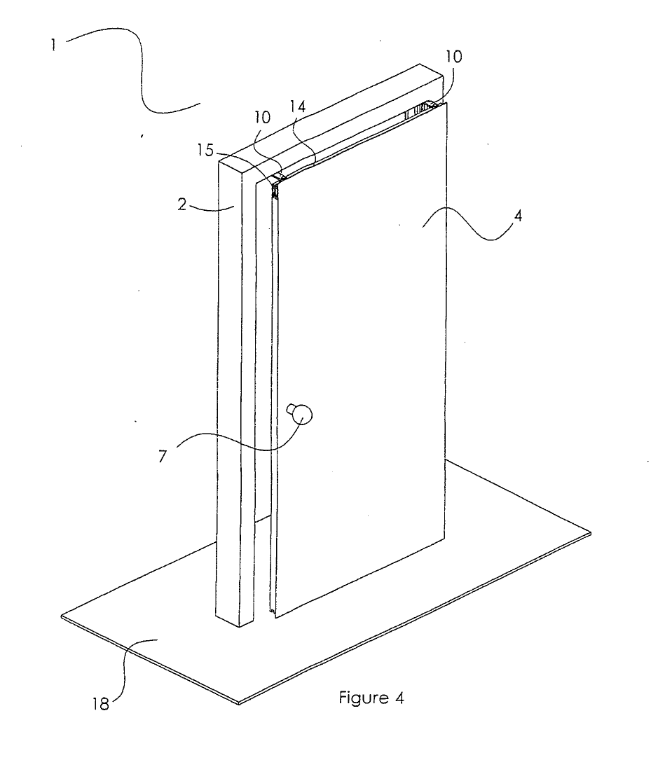

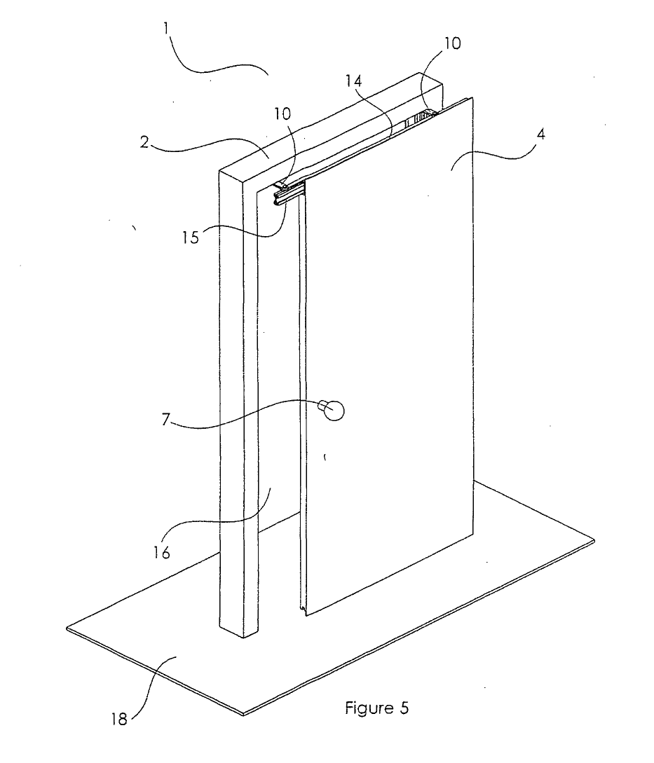

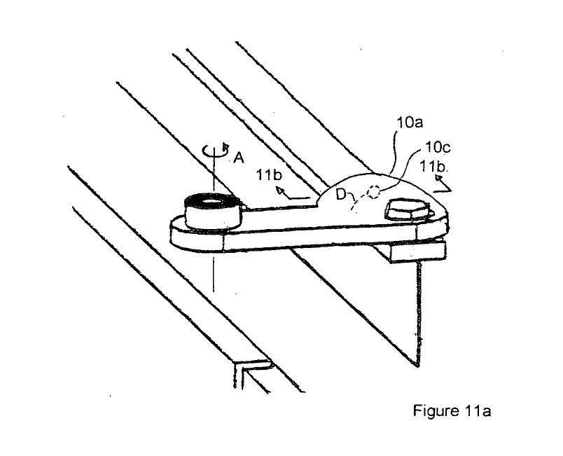

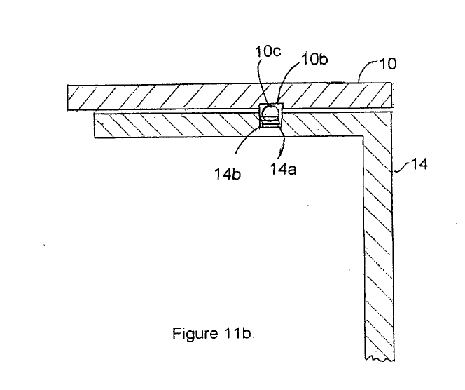

The door handle 7 is used to unlatch the door 4 from its fully closed position. After the door 4 is unlatched, swing arms 10 allow the door 4 to rotate out in direction A from the door jamb 2. FIGS. 3 and 4 show the door 4 partially rotated out from door jamb 2 and completely rotated out from doorjamb 2 respectively. In one embodiment such as seen in FIG. 11, one of the upper swing arms 10 includes an enlarged flange 10a or other structure which provides for a detent 10b. Detent 10b cooperates with a detent follower such as ball bearing 10c so as to engage and hold the swing arms 10 in their open position, 90 degrees from their closed position. With the detent and detent follower engaged, the door 4 is now free to slide in back and forth direction B along the drawer-type slide mechanism 15, and in particular towards the door opening 16 from the doors open position along the wall beside the doorway. FIG. 5 shows the door 4 in an intermediate slide position. The door 4 slides along the existing wall without requiring any modifications to the wall or to decorative moldings, and, because of the length of the swing arms, there is room for pictures or decorations on the wall behind the sliding door when the door is slid open.

When closing door 4, the door 4 slides so as to cover the door opening 16 along the drawer-type slide mechanism 15. Door 4 hits the end of the slide 15 as the door opening 16 is completely covered. As the door hits the end of the slide 15, the detent follower (such as ball bearing 10c) disengages from detent 10b. The swing arms are thereby released and the door 4 is allowed to swing into the door jamb 2 on the swing arms 10. The detent and its detent follower, inhibits pre-mature swinging of the swing arms forward their closed position, that is, prematurely while the door is sliding from fully slid open to slid closed over the door-frame. If the detent and follower releases too soon then the swing arms will commence rotation inward (in direction reverse to direction A) into the door frame before the door has fully returned to its position aligned with the door frame thereby causing the door to jam against the outside of the door frame as the door is sliding closed. Preferably the detent follower is resiliently biased into the detent, for example by spring 14a in pocket 14b in tee rail 14 acting on ball bearing 10c to urge it upwardly into detent 10b. A detent and follower may be provided for either or both of the upper swing arms 10.

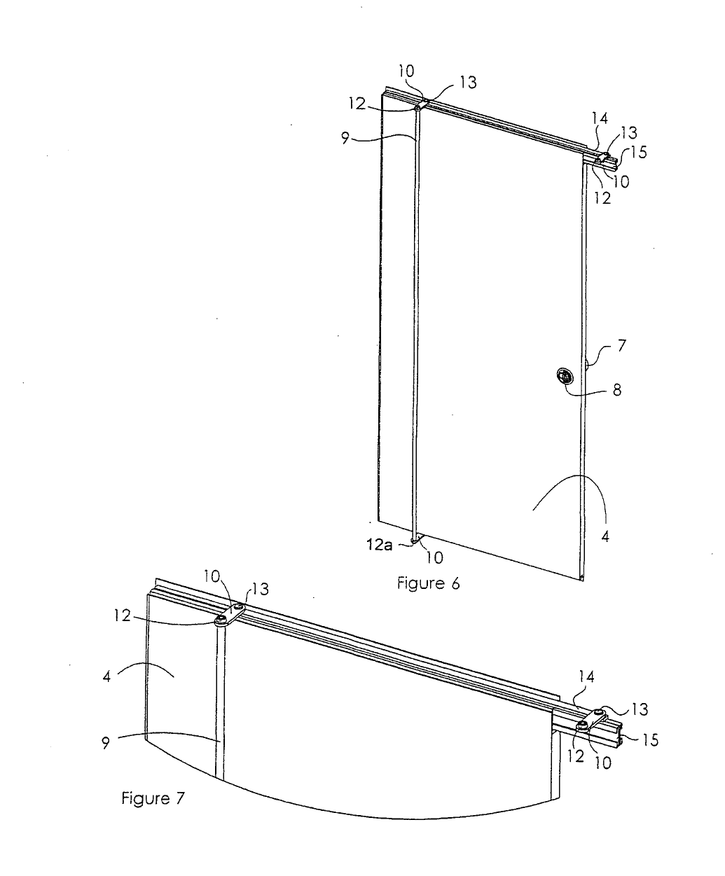

FIG. 6 shows the door assembly 1 from the opposite side, in a partially open state. The door jamb 2 is not shown so that the hardware associated with the swinging-sliding mechanism is visible. A low profile door handle 8 is located on this side of the door 4. FIG. 7 shows a close-up of the top portion of the mechanism.

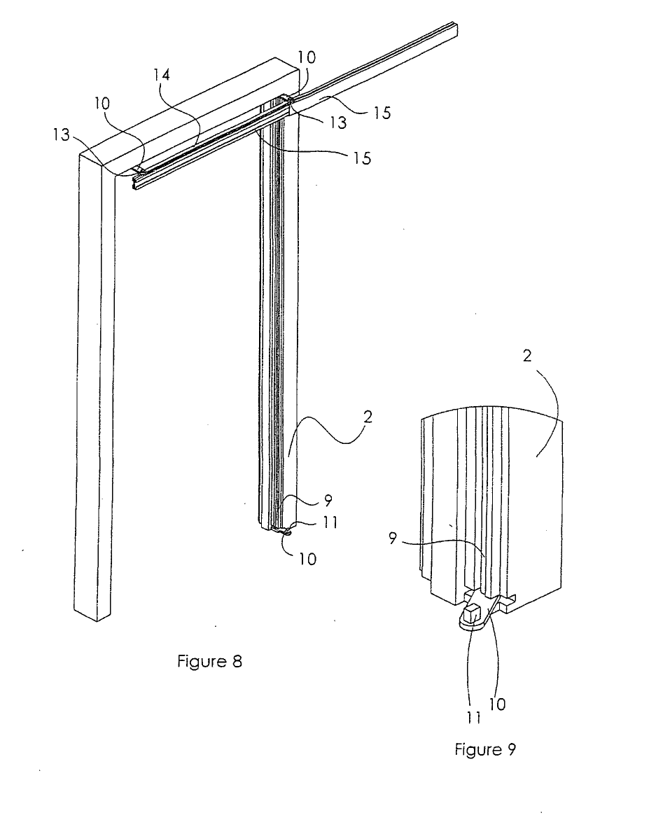

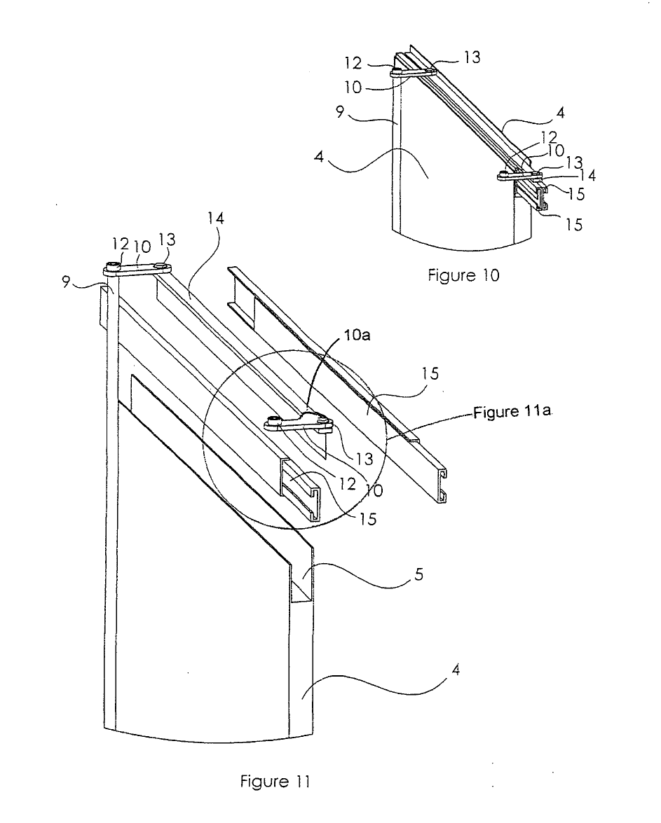

Pivot equalizer rod 9 mounts in a slot in the door jamb 2 as shown in FIG. 8. FIG. 9 shows a close-up of the mounting point in the bottom of the door jamb 2. The pivot equalizer rod 9 runs vertically down the entire door jamb 2. The pivot equalizer rod 9 gives the door 4 a rigid third point of support, for stability and to keep the bottom of the door 4 behaving similarly to the top. A double row ball bearing 12 in the top of the door jamb 2 and a thrust bearing 12a in the bottom of the door jamb 2 allow the pivot equalizer rod 9 to rotate in place about the rod's axis of rotation as seen in FIGS. 6 and 7. A swing arm 10 is located both on the top and bottom of the pivot equalizer rod 9. One end of the swing arm 10 is attached to the pivot equalizer rod 9 and the other end is mounted to the top of the tee rail 14 using a thrust bearing 13.

One the door hits the end of the its slide, so long as it hits with a force greater than the force acting in the same direction merely caused by the friction of the door as it slides closed, the resulting rotational force on the swing arms overcome the holding force of the detent follower biased into the corresponding detent, thereby allowing the swing arms to commence swinging closed and into the door frames as the swing arms thus swing closed (in a direction reverse to direction A) the detent follower (shown in dotted outline in FIG. 11a) rides underneath flange 10a following path D (also shown in dotted outline).

A drawer-type slide 15 is mounted to each side of the vertical portion for the tee rail 14. The tee rail 14 and drawer-type slides 15 are mounted inside the top door channel 5. The drawer-type slides 15 are secured to their respective sides of the top door channel 5. The swing arms 10 are mounted to the top of the Tee rail 14 by thrust bearings 13. The orientation of the swing arms 10 on the tee rail 14 allow the tee rail 14 and drawer-type slide 15 combination (and in turn the door 5 itself) to swing into the door jamb 2 while remaining planar to the door opening 16 the entire time.

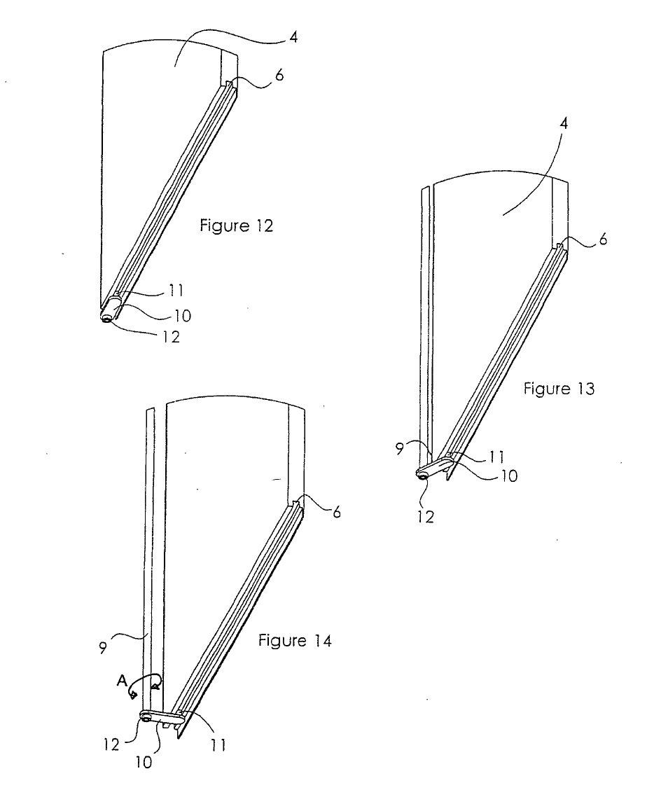

A sliding guide block 11 is rotatably mounted on the bottom swing arm 10. Sliding guide block 11 guides the bottom of the door 4 along the proper path while being opened or closed. The sliding guide block 11 can rotate in place in direction A. This allows the sliding guide block 11 to remain aligned with while sliding along the bottom door channel 6 while the door 4 is both sliding and rotating into the door jamb 2. FIGS. 12, 13 and 14 show the bottom edge of the door 4 moving from its stored position flush in door jamb 2, through an outwardly rotated position, to its fully open position fully removed from door jamb 2, ready for sliding in direction A. The sliding guide block 11 can be seen maintaining its orientation parallel to the bottom door channel 6 as the swing arm 10 is rotated about rod 9.

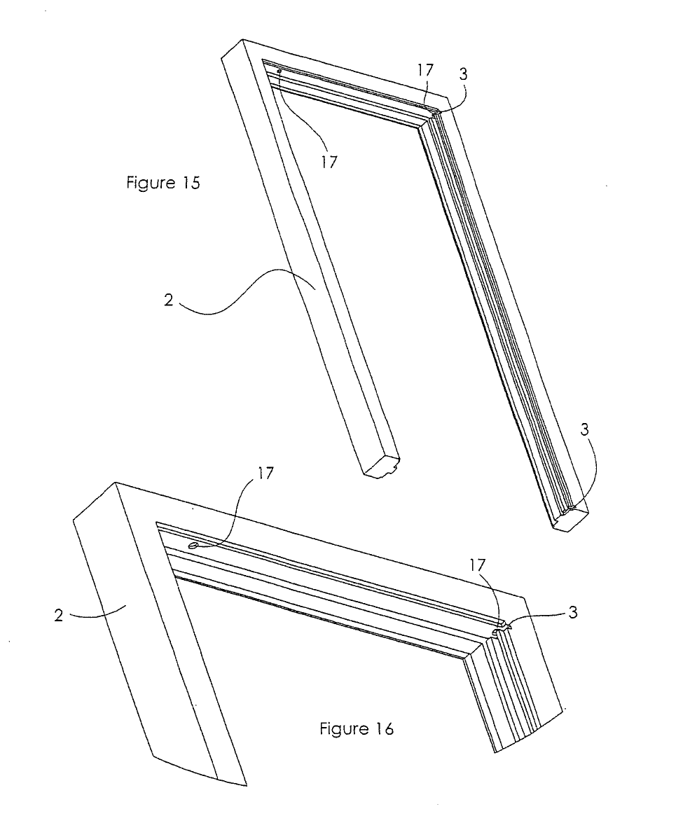

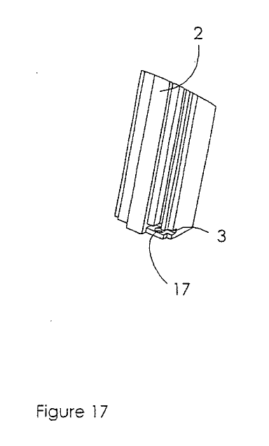

To accommodate the swinging-sliding mechanism, the door jamb 2 shown in FIGS. 15 and 16 include two bearing locations 17 and upper and lower notches 3 for the swing arms on rod 9 to rotate into. FIG. 17 shows a close-up inside bottom of the door jamb 2. A bearing mount 17 is adjacent the lower notch 3 to accommodate the lower rotating of the lower swing arm 10.

As will be apparent to those skilled in the art in the light of the foregoing disclosure, many alterations and modifications are possible in the practice of this invention without departing from the spirit or scope thereof.

What is claimed is:

1. A swinging-sliding door mechanism for mounting a door into a door frame having a horizontal upper jamb member and parallel vertical first and second jamb members depending downwardly from corresponding opposite first and second ends of the upper jamb member, wherein the door has horizontal upper and lower channels formed in the upper most and lower most ends of the door and wherein the door frame has an adjacent wall on which pictures maybe hung, said mechanism comprising:
(a) first and second upper swing arms each having opposite inner and outer ends, said inner ends rotatably mountable to the first and second ends of the upper jamb member for rotation in a substantially common horizontal plan between a closed position flush along the upper jamb member and an open position substantially perpendicular to the upper jamb member, wherein said inner end of said second upper swing arm is mountable into substantially a corresponding intersection between the upper jamb member and the vertical second jamb member,
(b) a slide-out having first and second ends and mountable in the upper channel of the door and so as to be aligned parallel with the upper jamb member, said slide-out having a length corresponding to the length of the upper channel of the door, said outer ends of said first and second swing arms rotatably mounted respectively to said first and second ends of said slide-out,
(c) a third swing arm having an inner and an opposite outer end, said outer end rotatably and slidably mountable to the lower channel in the door, said inner end of said third swing arm rotatably mountable at a lower end of the second jamb member,
(d) an elongate rod having opposite upper and lower ends rigidity mounted to, so as to extend vertically between, said inner ends of said second and third swing arms respectively, whereby rotation of either of said second or third swing arms causes corresponding rotation of the other of said second or third swing arms.

2. The mechanism of claim 1 wherein said slide-out includes a pair of drawer-type slides, each slide of said pair of drawer-type slides having a front and an opposite back, said slides mounted back-to-back, an elongate plate mounted sandwiched there between, so that said fronts of said slides are oppositely disposed and mountable into the upper channel in the door, said outer ends of said first and second swing arms rotatably mounted to said plate.

3. The mechanism of claim 1 wherein said first, second and third swing arms are longer than a thickness of the door by a thickness of the pictures in the adjacent wall.

4. The mechanism of claim 3 wherein the said swing arms are substantially twice as long as the thickness of the door, whereby the door will clear over the pictures on the wall adjacent the door and over which wall the door slides on said slide out.

5. The mechanism of claim 1 wherein said rod is at least partially embedded in the second jamb member.

6. The mechanism of claim 5 wherein said rod is completely embedded in second jamb member, and wherein the upper and lower ends of the second jamb member have notches therein, and wherein said second and third swing arms mate into said upper and lower notches respectively when said second swing arm is in said open position.

7. The mechanism of claim 6 wherein said notches provide rotational stops that arrest rotation of said second and third swing arms when said second and third swing arms are substantially perpendicular to the door and the door frame.

8. The mechanism of claim 1 further comprising a detent on at least one of said swing-arms, and a resiliently biased detent follower, said detent and said follower arresting said rotation of said swing arms when said swing arms are substantially perpendicular to the door and door-frame so as to inhibit rotation of said swing arms below a rotational force applied thereto, wherein said rotational force is at least equivalent to a force acting on said swing arms due to return sliding of the door along said slide out from a position covering the door frame.

9. The mechanism of claim 8 wherein a rotatably mounted guide member is rotatably mounted on said outer end of said third swing arm, and wherein said guide member is sized to slide along and within the lower channel in the door.
